(19) United States
(12) Patent Application Publication
(10) Pub. No.: US 2022/0025816 A1
(43) Pub. Date: Jan. 27, 2022

(54) SYSTEM FOR COOLING AN AIRCRAFT TURBOJET ENGINE

(71) Applicant: Safran Nacelles, GONFREVILLE L'ORCHER (FR)

(72) Inventors: Julien CORBIN, MOISSY CRAMAYEL (FR); David PEREIRA, MOISSY CRAMAYEL (FR); Vincent PEYRON, MOISSY CRAMAYEL (FR); Jean-Nicolas BOUCHOUT, MOISSY CRAMAYEL (FR); Caroline DANG, MOISSY CRAMAYEL (FR); Nicolas CHOUQUET, MOISSY CRAMAYEL (FR)

(73) Assignee: Safran Nacelles, GONFREVILLE L'ORCHER (FR)

(21) Appl. No.: 17/492,783

(22) Filed: Oct. 4, 2021

Related U.S. Application Data
(63) Continuation of application No. PCT/EP2020/058629, filed on Mar. 26, 2020.

(30) Foreign Application Priority Data
Apr. 3, 2019 (FR) 19/03544

(51) Int. Cl. F02C 7/18; F02C 9/00

(52) U.S. Cl. CPC F02C 7/18; F05D 2260/213; F05D 2220/323; F02C 9/00

(57) ABSTRACT

A cooling system for cooling an aircraft turbojet engine includes a first heat-exchanger for exchanging heat between a heat-transfer fluid and a lubricant of the turbojet engine, a second heat-exchanger for exchanging heat between the heat-transfer fluid and air, and a circulation duct for circulating heat-transfer fluid in a closed circuit. The cooling system further includes at least one regulating device for regulating the heat drawn from the lubricant, controlled by a control module of the regulating device that is configured to receive information according to the various flight phases.

### CROSS-REFERENCE TO RELATED APPLICATIONS

This application is a continuation of International Application No. PCT/EP2020/058629, filed on Mar. 26, 2020, which claims priority to and the benefit of FR 19/03544, filed on Apr. 3, 2019. The disclosures of the above applications are incorporated herein by reference.

### FIELD

The present disclosure relates to the field of systems for cooling an aircraft turbojet engine.

### BACKGROUND

The statements in this section merely provide background information related to the present disclosure and may not constitute prior art.

An aircraft can be propelled by one or several propulsion unit(s), each including a turbojet engine housed within a nacelle. Each propulsion unit is attached to the aircraft by a pylon generally located under or over a wing or at the level of the fuselage of the aircraft.

A turbojet engine may also be referred to as an engine and the terms engine and turbojet engine are used herein interchangeably.

A nacelle generally has a tubular structure including an upstream section including an air inlet upstream of the turbojet engine, a middle section configured to surround a fan of the turbojet engine, a downstream section which can accommodate a thrust reversal device and configured to surround the combustion chamber of the turbojet engine, and generally terminates in an ejection nozzle whose outlet is located downstream of the turbojet engine.

Furthermore, a nacelle typically includes an outer structure including a fixed portion and a movable portion (e.g., part of the thrust reversal device), and an Inner Fixed Structure (“IFS”), concentric with the outer structure. The IFS surrounds the core of the turbojet engine at the rear of the fan. These outer and inner structures define an annular flow path, also called a secondary flow path, configured to channel a secondary air stream, also referred to as a cold air stream, which circulates outside the turbojet engine.

The outer structure includes an outer fairing defining an outer aerodynamic surface, and an inner fairing defining an inner aerodynamic surface. The inner and outer fairings are connected upstream by a leading edge wall forming an air inlet lip.

In general, the turbojet engine includes a set of blades (e.g., a compressor and, in some constructions, an unducted fan or propeller) driven in rotation by a gas generator through a set of transmission components.

A controller member of the turbojet engine, called an Electronic Engine Controller (“EEC”) or a Full Authority Digital Engine Controller (“FADEC”) allows for controlling the engine at different flight phases of the aircraft.

The different flight phases of an aircraft include taxiing on the ground (taxi), pre-takeoff run-up, takeoff or aborted takeoff, climb, cruise, descent, approach, landing, aborted landing, and braking with thrust reversal.

A lubricant dispensing system is provided in the turbojet engine to provide lubrication and cooling of these transmission components. The lubricant is typically oil. In the following description, the terms lubricant and oil are used interchangeably.

A cooling system including a heat-exchanger can cool down the lubricant.

Some cooling systems include an air/oil exchanger using cold air sampled in the secondary flow path of the nacelle or in one of the first compressor stages to cool down the oil of the turbojet engine. Typically, such an air/oil exchanger is a finned exchanger that includes fins in the cold air stream which disturb the flow of the air stream in the secondary flow path or in the compressor, which results in pressure drops (e.g., drag), and therefore in losses in the performances of the aircraft in terms of fuel consumption (e.g., Fuel Burn (“FB”) parameter).

Other cooling systems include an air/oil exchanger using cold air sampled from outside the nacelle through a scoop disposed on the outer fairing of the nacelle. The cold air is brought to circulate through the exchanger and can be used in deicing the nacelle, once heated up by the lubricant, by circulation in pipes disposed in contact with the walls of the outer structure of the nacelle, for example at the level of the air inlet lip. Such a cooling system can provide improved control of the exchanged thermal energies, but the presence of scoops in the outer fairing of the nacelle typically results in a loss in the aerodynamic performances, in the same manner as a finned exchanger, and therefore in losses in the performances of the aircraft in terms of fuel consumption (e.g., Fuel Burn (“FB”) parameter).

Such cooling systems can cool down the turbojet engine according to the needs of the turbojet engine, which can vary according to the different flight phases.

### SUMMARY

This section provides a general summary of the disclosure and is not a comprehensive disclosure of its full scope or all of its features.

The teachings of the present disclosure provide for a system for cooling an aircraft turbojet engine of the type including a turbojet engine and a nacelle having an outer structure including an outer fairing defining an outer aerodynamic surface, and an inner fairing defining an inner aerodynamic surface. The cooling system includes at least one first exchanger, at least one second exchanger, and a circulation pipe. The at least one first exchanger is also referred to as a hot source exchanger, and exchanges heat between a heat-transfer fluid and a lubricant of the turbojet engine. The at least one second exchanger is also referred to as a cold source exchanger, and exchanges heat between the heat-transfer fluid and air. The circulation pipe is configured to circulate a heat-transfer fluid in closed circuit. The circulation pipe of the heat-transfer fluid includes at least one portion forming the cold source exchanger configured to be disposed in the nacelle in contact with the inner and/or outer fairing of the nacelle. The cooling system further includes at least one regulation device for regulating the heat extracted from the lubricant of the turbojet engine, controlled by a control module of the regulation device, configured to receive information according to the different flight phases.

The information according to the different flight phases is indirectly received by the control module. The information according to the different flight phases is received by a controller member of the turbojet engine and then transmitted to the control module.

The cold source exchanger is a surface exchanger.

The regulation device for regulating the heat extracted from the lubricant of the turbojet engine is a regulation device for regulating the cooling system. It regulates the heat exchange between the lubricant and the heat-transfer fluid in the hot source exchanger and/or the heat exchange between the heat-transfer fluid and air in the cold source exchanger. Thus, the cooling system is adapted to operate appropriately according to the needs of the different flight phases. In other words, the cooling system is configured to dissipate the heat of the lubricant of the turbojet engine due to the heat-transfer fluid being cooled down by the cold source exchanger integrated to the nacelle, according to its needs for each of the flight phases, which permits its operation without degrading the availability of the turbojet engine. According to other forms of the present disclosure, the cooling system can include one or more of the following optional feature(s) considered separately or according to any possible combination.

According to one form, the portion of the circulation pipe configured to be disposed in the nacelle in contact with the inner and/or outer fairing, is configured to be structurally integral with the inner and/or outer fairing of the nacelle.

By “structurally integral with the inner and/or outer fairing,” it should be understood that the portion of the circulation pope is formed by a double wall of the inner and/or outer fairing of the nacelle, that is to say the area in contact with air of each channel is formed by the outer or inner fairing of the nacelle.

According to one form, the regulation device for regulating the heat extracted from the lubricant of the turbojet engine includes a mechanical device for regulating the flow rate of circulation of the heat-transfer fluid, such as a mechanical pump.

Advantageously, the mechanical device for regulating the flow rate of circulation of the heat-transfer fluid is configured to extract the mechanical power necessary to ensure the flow rate of circulation from a shaft driven by the turbojet engine, for example at the level of an output of an accessory box (“AGB”) of the turbojet engine.

The control module of the mechanical device for regulating the flow rate of circulation of the heat-transfer fluid is a reducer member disposed between the mechanical device for regulating the flow rate of circulation of the heat-transfer fluid and an output of an accessory box (“AGB”) of the turbojet engine.

The information received by the control module from the mechanical device for regulating the flow rate of circulation of the heat-transfer fluid are the temperature and/or the pressure and/or the flow rate of the heat-transfer fluid and/or the temperature of the lubricant.

The cooling system further includes a temperature sensor and/or a pressure sensor and/or a flow rate sensor of the heat-transfer fluid, disposed in the circulation pipe of the heat-transfer fluid, and/or a temperature sensor of the lubricant, disposed in a circulation pipe of the lubricant.

Furthermore, the speed of the turbojet engine is variable according to the different flight phases of the aircraft. Thus, the control module of the mechanical device for regulating the flow rate of circulation of the heat-transfer fluid controls the mechanical device for regulating the flow rate of circulation of the heat-transfer fluid according to the flight phases of the aircraft.

According to one form, the mechanical device for regulating the flow rate of circulation of the heat-transfer fluid is configured to ensure a constant flow rate at the different flight phases.

According to another form, the mechanical device for regulating the flow rate of circulation of the heat-transfer fluid is configured to ensure a variable flow rate during the different flight phases, the flow rate being constant during the same flight phase.

According to another form, the mechanical device for regulating the flow rate of circulation of the heat-transfer fluid is configured to ensure a variable flow rate during the different flight phases, the flow rate being regulated in real-time according to the information received by the controller member of the turbojet engine.

According to one form, the regulation device for regulating the heat extracted from the lubricant of the turbojet engine includes an electrical device for regulating the flow rate of circulation of the heat-transfer fluid including an electric motor, such as an electric pump.

Advantageously, the electrical device for regulating the flow rate of circulation of the heat-transfer fluid is configured to extract the electric power sufficient to ensure the flow rate of circulation from an electric source originating either from the aircraft, or from the turbojet engine.

According to one form, the cooling system includes a power module configured to extract the electric power sufficient to ensure the flow rate of circulation from an electric source originating either from the aircraft, or from the turbojet engine, the power module being controlled by the control module of the electrical regulation device of the flow rate of circulation of the heat-transfer fluid.

The power module may be a simple switch member (e.g., a semiconductor switch or an electromechanical switch) or can consist of one or several power conversion stages (e.g., an AC/DC rectifier and a DC/AC inverter, for example).

According to one form, the control module of the electrical device for regulating the flow rate of circulation of the heat-transfer fluid is accommodated by a member of the turbojet engine such as a controller member of the turbojet engine (e.g., an EEC).

According to this form, the controller member of the turbojet engine is configured to monitor both the turbojet engine and the electrical device for regulating the flow rate of circulation of the heat-transfer fluid.

In an alternative form, the control module of the electrical device for regulating the flow rate of circulation of the heat-transfer fluid is a control module dedicated to the electrical device for regulating the flow rate of circulation of the heat-transfer fluid, the module being controlled by a member of the turbojet engine such as a controller member of the turbojet engine.

According to one form, the power module is accommodated by a member of the turbojet engine, such as a controller member of the turbojet engine (e.g., an EEC) or any other electronic equipment of the turbojet engine.

In another alternative form, the power module is dedicated to the electrical device for regulating the flow rate of circulation of the heat-transfer fluid.

The information received by the control module of the electrical device for regulating the flow rate of circulation of the heat-transfer fluid is the temperature and/or the pressure and/or the flow rate of the heat-transfer fluid and/or the temperature of the lubricant.

The cooling system further includes a temperature sensor and/or a pressure sensor ad/or a flow rate sensor of the heat-transfer fluid, disposed in the circulation pipe of the heat-transfer fluid, and/or a temperature sensor of the lubricant, disposed in a circulation pipe of the lubricant.

According to one form, the electrical device for regulating the flow rate of circulation of the heat-transfer fluid is an electric pump with an asynchronous or synchronous or Brushless DC (“BLDC”) or direct current type electric motor.

The control module of the electric pump is of the digital or analog type and is adapted to control the power module so as to ensure a function of servo-control of the rotational speed of the pump.

According to one form, the electric motor and the power module are multi-phase. When the number of electrical phases of the motor is greater than three, this form allows for some tolerance to failures, which can therefore improve the operational availability of the cooling system.

According to one form, the power module is controlled by several independent control modules of the electrical device for regulating the flow rate of circulation of the heat-transfer fluid. By “independent,” it should be understood to mean functionally independent and electrically segregated from each other.

The cooling system can advantageously include an electrical switch device that permits selecting either one of the control modules of the electrical means for regulating the flow rate of circulation of the heat-transfer fluid.

According to one form, the cooling system includes several electrical devices for regulating the flow rate of circulation of the heat-transfer fluid mounted in parallel in the circulation pipe of the heat-transfer fluid, each electrical device for regulating the flow rate of circulation of the heat-transfer fluid including an independent power module, controlled by a control module dedicated to the electrical device for regulating the flow rate of circulation of the heat-transfer fluid. The control module is controlled by a controller member of the turbojet engine. By “independent,” it should be understood to mean functionally independent and electrically segregated from each other.

According to one form, these electrical devices for regulating the flow rate of circulation of the heat-transfer fluid, disposed in parallel, are controlled in an active/active mode. In other words, they are all operational at a time point T and share the total flow rate to be supplied. Thus, in case of malfunction of one electrical device for regulating the flow rate of circulation of the heat-transfer fluid, the operational electrical device for regulating the flow rate of circulation of the heat-transfer fluid ensures the excess flow rate that is not supplied by the malfunctioned one.

In an alternative form, these electrical devices for regulating the flow rate of circulation of the heat-transfer fluid, disposed in parallel, are controlled in an active/inactive (also referred to as “stand-by”) mode. In other words, only one electrical device for regulating the flow rate of circulation of the heat-transfer fluid is active at a time point T whereas the other ones are inactive and are activated in case of malfunction of the active electrical device for regulating the flow rate of circulation of the heat-transfer fluid.

According to one form, the electrical device regulating the flow rate of circulation of the heat-transfer fluid is configured to ensure a constant flow rate at the different flight phases.

According to another form, the electrical device for regulating the flow rate of circulation of the heat-transfer fluid is configured to ensure a variable flow rate throughout the different flight phases, the flow rate being constant during the same flight phase.

According to another form, the electrical device for regulating the flow rate of circulation of the heat-transfer fluid is configured to ensure a variable flow rate throughout the different flight phases, the flow rate being regulated in real-time according to the information received by the controller member of the turbojet engine.

Furthermore, such cooling systems are subjected to thermal, vibrational, altitude pressure, etc. constraints related to the harsh environment in which the turbojet engine nacelle evolves throughout the flight phases. In particular, by the effect of temperature, the heat-transfer fluid expands. Thus, it can be beneficial for the cooling system to be able to accommodate this variation of the volume occupied by the heat-transfer fluid.

Thus, the cooling system includes an expansion tank accommodating the variation of the volume occupied by the heat-transfer fluid.

According to one form, the expansion tank is closed. Thus, the pressure in the expansion tank is directly related to the volume occupied by the heat-transfer fluid in the expansion tank. This form advantageously allows for controlling a maximum and/or minimum pressure in some portions of the circulation pipe of the heat-transfer fluid by acting only on the capacity (i.e., volume) of the tank.

Thus, the pressure is limited in some portions, for example in the cold source exchanger, which avoids a breakup of the circulation pipe of the heat-transfer fluid, and a minimum pressure is ensured in other portions, such as for example at the inlet of the regulation device for regulating the flow rate of circulation of the heat-transfer fluid.

According to one form, an electrical device for regulating the flow rate of the heat-transfer fluid is integrated to the expansion tank. This configuration can save space, in order to facilitate the integration of the cooling system in the aerodynamic lines of the nacelle.

Thus, the cooling system according to the present disclosure addresses sizing requirements so as to permit integration thereof in the aerodynamic lines of the nacelle.

According to this form, the electrical device for regulating the flow rate of the heat-transfer fluid is immersed in the expansion tank.

In an alternative form, the electrical device for regulating the flow rate of the heat-transfer fluid is integrated to a wall of the expansion tank.

According to this form, the electrical device for regulating the flow rate of the heat-transfer fluid is removable.

According to one form, the regulation device for regulating the heat extracted from the lubricant is a relief member adapted to divert at least partly the circulation of the heat-transfer fluid, so that it does not circulate or circulates with a partial flow rate in the hot source exchanger.

According to one form, the relief member is disposed in the closed loop, between the hot source exchanger and the cold source exchanger.

According to one form, the relief member is a valve disposed in a pipe parallel to the hot source exchanger.

According to one form, the regulation device for regulating the heat extracted from the lubricant is a relief member adapted to divert at least partly the circulation of the lubricant, so that it does not circulate or circulates with a partial flow rate in the hot source exchanger.

According to this form, the relief member is disposed in a circulation pipe of the lubricant.

According to one form, the relief member is a valve disposed in a pipe parallel to the hot source exchanger.

According to one form, the cooling system includes a relief member adapted to divert at least partly the circulation of the heat-transfer fluid, so that it does not circulate or circulates with a partial flow rate in the hot source exchanger, and a relief member adapted to divert at least partly the circulation of the lubricant, so that it does not circulate or circulates with a partial flow rate in the hot source exchanger.

According to one form, the cooling system includes a mechanical or electrical device for regulating the flow rate of the heat-transfer fluid and a relief member adapted to divert the circulation of the heat-transfer fluid and/or of the lubricant, so that it does not circulate or circulates with a partial flow rate in the hot source exchanger.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a cooling system including a mechanical device for regulating the flow rate of circulation of the heat-transfer fluid, in accordance with the teachings of the present disclosure;

FIG. 2 is a schematic view of a cooling system including an electrical device for regulating the flow rate of circulation of the heat-transfer fluid, in accordance with the teachings of the present disclosure;

FIG. 3 is a schematic view of a cooling system including an electrical device for regulating the flow rate of circulation of the heat-transfer fluid of a second construction, in accordance with the teachings of the present disclosure;

FIG. 4 is a schematic view of a cooling system including an electrical device for regulating the flow rate of circulation of the heat-transfer fluid of a third construction, in accordance with the teachings of the present disclosure;

FIG. 5 is a schematic view of a cooling system including an electrical device for regulating the flow rate of circulation of the heat-transfer fluid of a fourth construction, in accordance with the teachings of the present disclosure;

FIG. 6 is a schematic view of a cooling system including an electrical device for regulating the flow rate of circulation of the heat-transfer fluid of a fifth construction, in accordance with the teachings of the present disclosure;

FIG. 7A is a graph illustrating a first operating mode of the regulation devices of FIGS. 1 to 6, in accordance with the teachings of the present disclosure;

FIG. 7B is a graph illustrating a second operating mode of the regulation devices of FIGS. 1 to 6, in accordance with the teachings of the present disclosure;

FIG. 7C is a graph illustrating a third operating mode of the regulation devices of FIGS. 1 to 6, in accordance with the teachings of the present disclosure;

FIG. 8 is a schematic view of a cooling system including a relief member adapted to divert at least partly the circulation of the heat-transfer fluid, in accordance with the teachings of the present disclosure;

FIG. 9 is a schematic view of a cooling system including a relief member adapted to divert at least partly the circulation of the lubricant, in accordance with the teachings of the present disclosure;

FIG. 10 is a schematic view of the cooling system of FIG. 2 including two cold source exchangers, in accordance with the teachings of the present disclosure;

FIG. 11A is a schematic view illustrating a first construction of an expansion tank including an electrical device for regulating the flow rate of circulation of the heat-transfer fluid, in accordance with the teachings of the present disclosure;

FIG. 11B is a schematic view illustrating a second construction of an expansion tank including an electrical device for regulating the flow rate of circulation of the heat-transfer fluid, in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following description and in the claims, identical, similar or analogous components will be referred to by the same reference numerals.

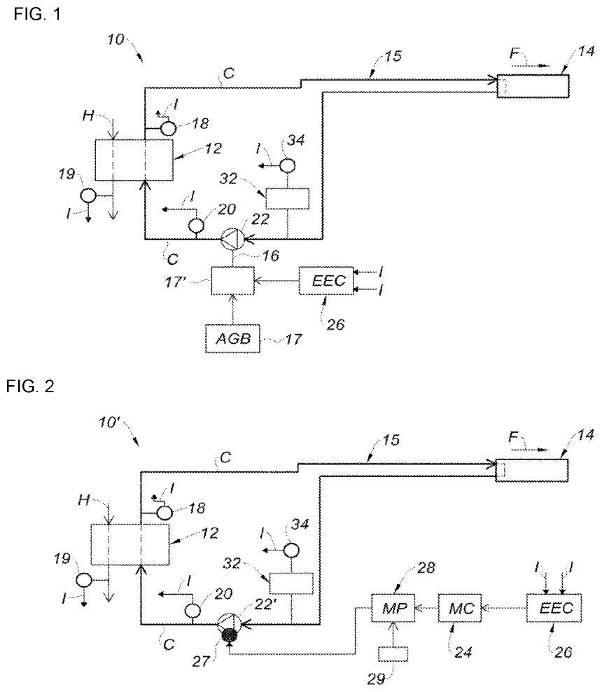

FIG. 1 illustrates a system 10 for cooling a lubricant H of an turbojet engine assembly of an aircraft. The cooling system 10 includes a first exchanger 12, also referred to herein as the hot source exchanger, that transfers heat between a heat-transfer fluid C and the lubricant H, a second exchanger 14, also referred to herein as the cold source exchanger, that transfers heat between the heat-transfer fluid C and air F, and a circulation pipe 15 for circulating the heat-transfer fluid C in a closed circuit.

The cooling system 10 includes, on the circulation pipe 15, an expansion tank 32 and a mechanical pump 22.

The expansion tank 32 is closed so that its volume is related to the pressure of the circulation pipe 15, i.e., the pressure of the heat-transfer fluid C.

The selection of the volume of the expansion tank (i.e., its sizing) inhibits exceeding a maximum pressure in some portions of the circulation pipe 15, typically between 5 and 10 bars at maximum in the hot source and/or cold source exchangers when the heat-transfer fluid has a temperature between 50 and 150° C.

Furthermore, the selection of the volume of the expansion tank ensures a minimum pressure in some portions of the circulation pipe 15, typically between 0 and 1 bar at minimum at the pump inlet when the heat-transfer fluid has a temperature between −55° C. and 0° C.

The mechanical pump 22 includes a mechanical shaft 16 configured to be driven by an output of an accessory box 17 (“AGB”) of the turbojet engine via a reducer member 17′. The accessory box 17 is a member of the turbojet engine. Thus, the output of the accessory box 17 is driven according to the speed of the turbojet engine which varies according to the different flight phases.

The mechanical pump 22 is a device for regulating the flow rate of circulation of the heat-transfer fluid C in the circulation pipe 15, and more specifically a mechanical device for regulating the flow rate of circulation of the heat-transfer fluid C in the circulation pipe 15. Furthermore, the mechanical pump 22 is a device for regulating the heat extracted from the lubricant H of the turbojet engine.

The accessory box 17 is a mechanical power source.

The reducer member 17′ is a control module of the mechanical pump 22, which allows for controlling of the mechanical pump 22 according to the speed of the turbojet engine which varies according to the different flight phases.

The reducer member 17′ is controlled by a controller member 26 (“EEC”) of the turbojet engine. Thus, the controller member 26 of the turbojet engine ensures a mechanical pump regulation function.

Temperature sensor 18 and pressure sensor 20 are disposed in the circulation pipe 15 to measure the temperature and pressure, respectively, of the heat-transfer fluid C. Furthermore, a temperature sensor 19 of the lubricant H is disposed in a circulation pipe of the lubricant H. The temperature sensors 18, 19, and the pressure sensor 20, send back information I to the controller member 26 of the turbojet engine which is adapted to control the reducer member 17′ according to all or part of this information I, throughout the different flight phases. Thus, the controller member 26 of the turbojet engine establishes regulation commands towards the reducer member 17′, according to the heat dissipation needs of the turbojet engine, these needs being variable according to the flight phase.

The expansion tank 32 further includes a pressure sensor 34 configured to send back information I to the controller member 26 of the turbojet engine.

In the form of FIG. 1, the pressure sensor 20 of the heat-transfer fluid C is disposed in the circulation pipe 15, at the pump 22′ outlet, the temperature sensor 18 of the heat-transfer C is disposed in the circulation pipe 15, at the outlet of the hot source exchanger 12, and the temperature sensor 19 of the lubricant H is disposed in a circulation pipe of the lubricant H, at the outlet of the hot source exchanger 12.

In an alternative form, not specifically shown, the cooling system 10 includes a pressure sensor at the pump inlet.

In another alternative form, not specifically shown, the cooling system 10 includes a pressure sensor at the pump outlet and inlet.

Thus, the reducer member 17′ is configured to receive information according to the different flight phases, via the controller member 26 of the turbojet engine.

The reducer member 17′ belongs to the turbojet engine. Thus, the control module of the mechanical pump 22 is accommodated by a member of the turbojet engine.

The reducer member 17′ may have a fixed or variable reduction ratio.

FIG. 2 represents a cooling system 10′ including an electric pump 22′ according to a first form.

The electric pump 22′ includes an electric motor 27.

The electric pump 22′ is a device for regulating the flow rate of circulation of the heat-transfer fluid C in the circulation pipe 15, and more specifically an electrical device for regulating the flow rate of circulation of the heat-transfer fluid C in the circulation pipe 15. Furthermore, the electrical pump 22′ is a device for regulating the heat extracted from the lubricant H of the turbojet engine.

In this form, the cooling system 10′ includes a power module 28 powered by an electric source 29 originating from the turbojet engine or from the aircraft and a control module 24 of the power module 28. The power module 28 is configured to extract the electric power necessary to ensure the flow rate of circulation to the electric source 29.

The control module 24 of the electric pump 22′ is adapted to control the power module 28 to ensure control and electric power supply of the electric pump 22′.

The control module 24 of the electric pump 22′ is controlled by a controller member 26 (“EEC”) of the turbojet engine. Thus, the controller member 26 of the turbojet engine ensures a function of regulation of the rotational speed of the pump.

Heat-transfer fluid C temperature sensor 18 and pressure sensor 20 are disposed in the circulation pipe 15 of the heat-transfer fluid C. Furthermore, a temperature sensor 19 of the lubricant H is disposed in a circulation pipe of the lubricant H. The temperature sensors 18, 19, and the pressure sensor 20, send back information I to the controller member 26 of the turbojet engine which is adapted to control the control module 24 of the electric pump 22′ according to all or part of this information I, throughout the different flight phases. Thus, the controller member 26 of the turbojet engine establishes regulation commands towards the control module 24 of the electric pump 22′, according to the heat dissipation needs of the turbojet engine, these needs being variable according to the flight phase.

The expansion tank 32 further includes a pressure sensor 34 configured to send back information I to the controller member 26 of the turbojet engine.

In the form of FIG. 2, the pressure sensor 20 of the heat-transfer fluid C is disposed in the circulation pipe 15, at the pump 22′ outlet, the temperature sensor 18 of the heat-transfer fluid C is disposed in the circulation pipe 15, at the outlet of the hot source exchanger 12, and the temperature sensor 19 of the lubricant H is disposed in a circulation pipe of the lubricant H, at the outlet of the hot source exchanger 12.

In an alternative form, not specifically shown, the cooling system 10′ includes a pressure sensor at the pump inlet.

In another alternative form, not specifically shown, the cooling system 10′ includes a pressure sensor at the pump outlet and inlet.

In the form represented in FIG. 2, the control module 24 and the power module 28 of the electric pump 22′ are modules dedicated to the electric pump 22′.

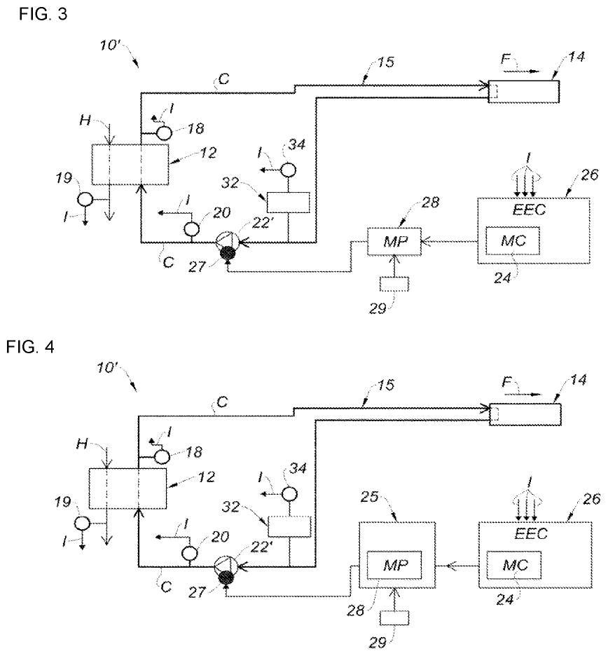

FIG. 3 represents a cooling system 10′ including an electric pump 22′ according to a second form.

In the form represented in FIG. 3, the control module 24 of the electric pump 22′ is accommodated by the controller member 26 of the turbojet engine.

Thus, the controller member 26 of the turbojet engine ensures a turbojet engine control function and an electric pump 22′ control function.

Furthermore, in this form, the power module 28 is dedicated to the electric pump 22′. The power module 28 ensures a pump 22′ electric power supply function.

FIG. 4 represents a cooling system 10′ including an electric pump 22′ according to a third form.

In the form represented in FIG. 4, the control module 24 of the electric pump 22′ is accommodated by the controller member 26 of the turbojet engine and the power module 28 is accommodated by a member 25 of the turbojet engine.

In another non-represented form, the power module 28 and the control module 24 of the electric pump 22′ are accommodated by the controller member 26 of the turbojet engine.

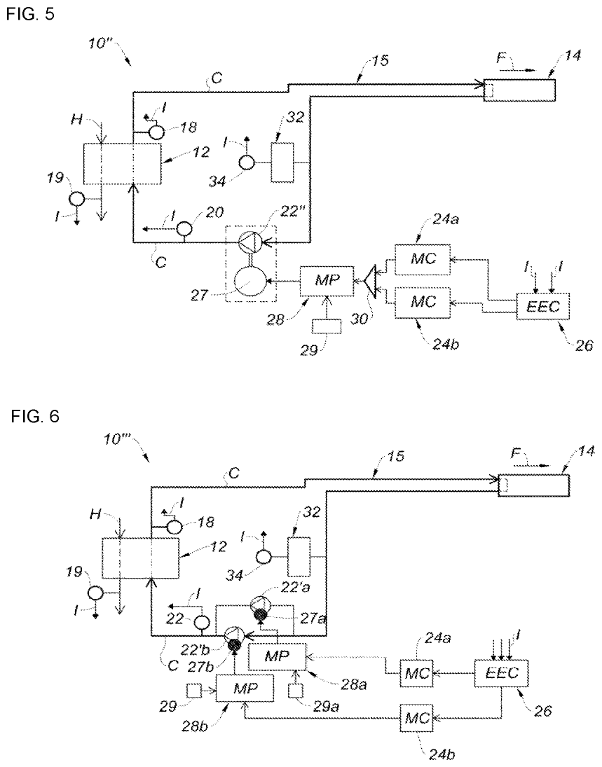

FIG. 5 represents a cooling system 10″ including an electric pump 22″ according to a fourth form.

In this form, the electric motor 27 and the power module 28 of the electric pump 22″, are multi-phase.

When the number of electrical phases of the motor 27 is greater than three, this feature allows for some tolerance to malfunction, which therefore improves the operational availability of the cooling system 10″.

Thus, this form illustrates a tradeoff between improving the availability of the cooling system 10″ and the mass of the cooling system 10″. In this form, the power module 28 and the electric pump 22″ are not replicated.

The cooling system 10″ includes two independent control modules 24a, 24b of the electric pump 22″, and the cooling system 10″ includes an electrical switch device 30 permitting the selecting of either one of the control modules 24a, 24b of the electric pump 22″.

FIG. 6 represents a cooling system 10′″ including two electric pumps 22′a, 22′b, mounted in parallel in the circulation pipe 15 of the heat-transfer fluid C, each pump including an electric motor 27a, 27b.

In this form, each pump 22′a, 22′b includes a power module 28a, 28b, and a control module 24a, 24b, independent of each other, dedicated to the electric pump 22′a, 22′b. The control modules 24a, 24b are controlled by the controller member 26 of the turbojet engine.

Each power module 28a, 28b is powered by an electric source 29a, 29b.

In a non-represented form, each pump 22′a, 22′b includes an independent power module 28a, 28b, dedicated to the electric pump 22′a, 22′b, and an independent control module 24a, 24b, accommodated by the controller member 26 of the turbojet engine.

In another non-represented form, each pump 22′a, 22′b includes an independent power module 28a, 28b, accommodated by a member 25 of the turbojet engine or the controller member 26 of the turbojet engine, and a control module 24 accommodated by the controller member 26 of the turbojet engine.

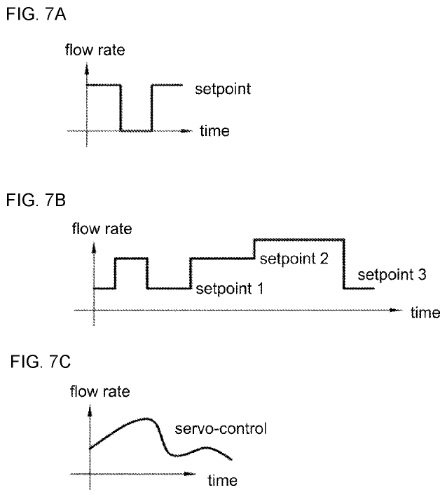

FIG. 7A is a graph of flow rate over time and illustrates that the device for regulating the heat extracted from the lubricant is ensured by a device for regulating the flow rate of circulation of the heat-transfer fluid C. This regulation is ensured by an on-off type power supply of the mechanical pump 22 or the electric pump 22′, 22″, 22′a, 22′b. As shown in FIG. 7A, the pump 22, 22′, 22″, 22′a, 22′b outputs a constant flow rate at the different flight phases when it is powered.

In a form illustrated in the graph of flow rate over time shown in FIG. 7B, the regulation of the flow rate of circulation of the heat-transfer fluid C is ensured by a variable flow rate throughout the different flight phases, the flow rate being constant during the same flight phase.

In a form illustrated in the graph of flow rate over time shown in FIG. 7C, the regulation of the flow rate of circulation of the heat-transfer fluid C is ensured by a variable flow rate throughout the different flight phases, the flow rate being regulated in real-time according to the information I received by the controller member 26 of the turbojet engine.

This form is referred to as flow rate real-time servo-control.

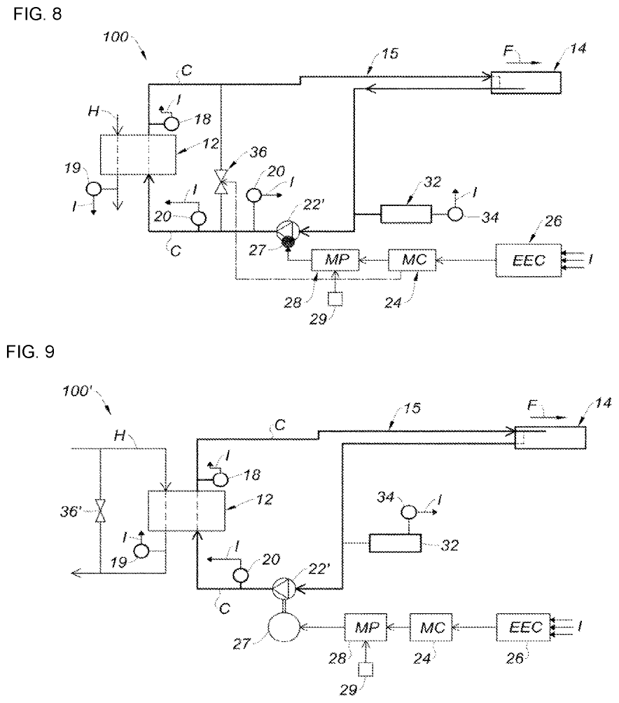

FIG. 8 represents a cooling system 100 including a relief member 36 adapted to at least partly divert the circulation of the heat-transfer fluid C, so that it does not circulate or circulates with a partial flow rate in the hot source exchanger 12. The relief member 36 is a bypass valve disposed in the closed loop of the circulation pipe 15 of the heat-transfer fluid C, between the hot source exchanger 12 and the cold source exchanger 14.

More particularly, the bypass valve 36 is disposed in a pipe parallel to the hot source exchanger 12.

The bypass valve 36 is a relief member adapted to at least partly divert the circulation of the heat-transfer fluid C. This is a device for regulating the heat extracted from the lubricant H.

The cooling system 100 of this form further includes an expansion tank as described with reference to FIG. 1, an electric pump 22′ as described with reference to FIG. 2, as well as temperature and pressure sensors as described with reference to FIG. 2.

The control module 24 of the electric pump 22′ is also configured to control the bypass valve 36.

The bypass valve 36 is a passive member such as a thermostat or an active member such as a solenoid valve.

In a non-represented form, there is a control module dedicated to the bypass valve which allows controlling the bypass valve 36.

FIG. 9 illustrates a cooling system 100′ including a relief member 36′ adapted to at least partly divert the circulation of the lubricant H, so that it does not circulate or circulates with a partial flow rate in the hot source exchanger 12, the relief member 36′ being a bypass valve disposed in the circulation pipe 15 of the lubricant H.

The bypass valve 36′ is a passive member such as a thermostat or an active member such as a solenoid valve.

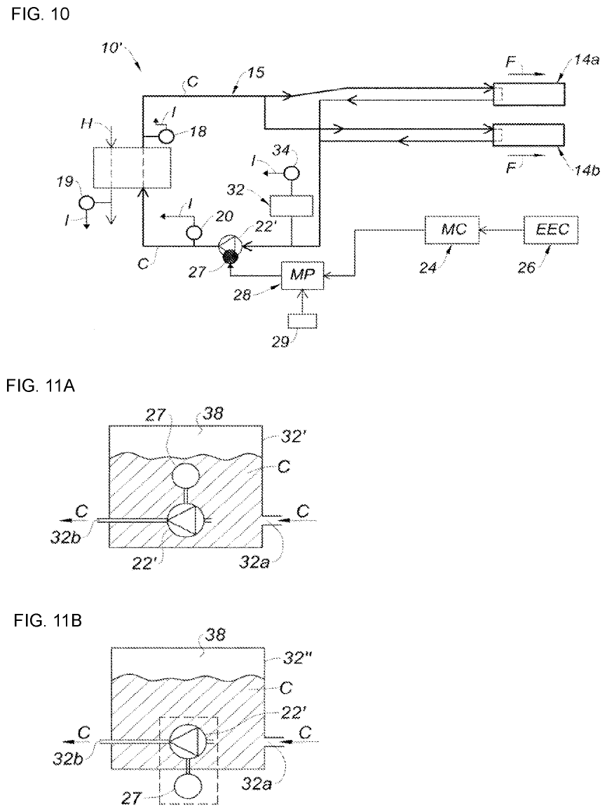

FIG. 10 illustrates the lubricant cooling system 10′ of FIG. 2 including two cold source exchangers 14a, 14b disposed in parallel.

FIG. 11A illustrates a first construction of an expansion tank 32′ including an electric pump 22′ serving as an electrical device for regulating the flow rate of circulation of the heat-transfer fluid C.

The expansion tank 32′ is filled with a determined volume of heat-transfer fluid C thereby leaving a gaseous headspace 38 in the expansion tank 32′. The expansion tank 32′ has a heat-transfer fluid inlet 32a and a heat-transfer fluid outlet 32b.

The electric pump 22′ and its electric motor 27 are immersed in the expansion tank 32′. The electric pump 22′ is connected to the heat-transfer fluid outlet 32b so as to regulate the flow rate of circulation of the heat-transfer fluid C at the outlet 32b of the expansion tank 32′.

FIG. 11B illustrates a second construction of an expansion tank 32″ including an electric pump 22′ serving as an electrical device for regulating the flow rate of circulation of the heat-transfer fluid C.

The expansion tank 32″ is filled with a determined volume of heat-transfer fluid C thereby leaving a gaseous headspace 38 in the expansion tank 32″. The expansion tank 32″ has a heat-transfer fluid inlet 32a and a heat-transfer fluid outlet 32b.

The electric pump 22′ and its electric motor 27 are integrated to a wall of the expansion tank 32′, so that the electric pump 22′ and its electric motor 27 are removable.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A cooling system for a turbojet engine assembly for an aircraft, the turbojet engine assembly including a turbojet engine and a nacelle, the nacelle having an outer structure including an outer fairing defining an outer aerodynamic surface, and an inner fairing defining an inner aerodynamic surface, the cooling system comprising:
a first heat-exchanger configured to transfer heat between a heat-transfer fluid and a lubricant of the turbojet engine;
a second heat-exchanger configured to transfer heat between the heat-transfer fluid and air; and
a first circulation pipe configured to circulate the heat-transfer fluid in closed circuit, the circulation pipe including a portion forming the second heat-exchanger and configured to be disposed in the nacelle in contact with the inner fairing of the nacelle, the outer fairing of the nacelle, or both the inner and outer fairings of the nacelle,
wherein the cooling system comprises at least one regulation device for regulating heat extracted from the lubricant of the turbojet engine, the at least one regulation device being controlled by a control module configured to receive information according to different flight phases via a controller member of the turbojet engine,
wherein the at least one regulation device for regulating heat extracted from the lubricant of the turbojet engine comprises a plurality of electrical devices for regulating a flow rate of the heat-transfer fluid, each electrical device of the plurality of electrical devices for regulating the flow rate of the heat-transfer fluid including an electric motor,
wherein the electrical devices of the plurality of electrical devices for regulating the flow rate of the heat-transfer fluid are mounted in parallel in the circulation pipe, and
wherein each electrical device of the plurality of electrical devices for regulating the flow rate of the heat-transfer fluid comprises an independent power module, controlled by the control module, the control module being dedicated to the plurality of electrical devices for regulating the flow rate of the heat-transfer fluid, the control module being controlled by the controller member of the turbojet engine.

2. The cooling system according to claim 1, wherein the at least one regulation device for regulating heat extracted from the lubricant of the turbojet engine includes a mechanical device for regulating the flow rate of the heat-transfer fluid.

3. The cooling system according to the claim 2, wherein the control module is a reducer member disposed between the mechanical device for regulating flow rate of the heat-transfer fluid and an output of an accessory box of the turbojet engine.

4. The cooling system according to claim 1, wherein the power module is configured to extract an electric power necessary to ensure the flow rate from an electric source originating either from the aircraft, or from the turbojet engine, the power module being controlled by the control module.

5. The cooling system according to claim 4, wherein the electric motor and the power module are multi-phase with a number of electrical phases greater than three.

6. The cooling system according to the claim 5, wherein the power module is controlled by a plurality of independent control modules of the electrical device for regulating the flow rate of the heat-transfer fluid, wherein the cooling system further includes an electrical switch device configured to permit selection of either of the plurality of independent control modules of the electrical device for regulating the flow rate of the heat-transfer fluid.

7. The cooling system according to claim 1, wherein the control module is accommodated by a controller member of the turbojet engine.

8. The cooling system according to claim 1, wherein the control module is dedicated to the electrical device for regulating the flow rate of the heat-transfer fluid, the control module being controlled by a controller member of the turbojet engine.

9. The cooling system according to claim 1, wherein the power module is accommodated by a controller member of the turbojet engine or an electronic equipment of the turbojet engine.

10. The cooling system according to claim 1, wherein the power module is dedicated to the electrical device for regulating the flow rate of the heat-transfer fluid.

11. The cooling system according to claim 1 further comprising at least one of:
a temperature sensor disposed in the circulation pipe of the heat-transfer fluid, a pressure sensor disposed in the circulation pipe of the heat-transfer fluid, a flow rate sensor disposed in the circulation pipe of the heat-transfer fluid, and a temperature sensor disposed in a second circulation pipe that is configured to circulate the lubricant.

12. The cooling system according to claim 1, including an expansion tank accommodating heat-transfer fluid volume variation, the expansion tank being closed in order to define, in some portions of the circulation pipe, a maximum pressure, a minimum pressure, or both the maximum pressure and the minimum pressure.

13. The cooling system according to claim 1, wherein the at least one regulation device for regulating the heat extracted from the lubricant comprises a relief member adapted to at least partly divert circulation of the heat-transfer fluid so that the heat-transfer fluid does not circulate or circulates with a partial flow rate in the first heat-exchanger.

14. The cooling system according to claim 1, wherein the at least one regulation device for regulating the heat extracted from the lubricant is a relief member adapted to at least partly divert circulation of the lubricant, so that the lubricant does not circulate or circulates with a partial flow rate in the first heat-exchanger.
